(19) United States
(12) Patent Application Publication
(10) Pub. No.: US 2025/0115517 A1
(43) Pub. Date: Apr. 10, 2025

(54) SILICA SUPPLEMENTARY CEMENTITIOUS MATERIALS

(71) Applicant: IMPERIAL COLLEGE INNOVATIONS LIMITED, London (GB)

(72) Inventors: Samuel DRAPER, LONDON (GB); Barnaby SHANKS, LONDON (GB); Christopher CHEESEMAN, LONDON (GB); Hong WONG, LONDON (GB)

(21) Appl. No.: 18/730,212

(22) PCT Filed: Jan. 18, 2023
(86) PCT No.: PCT/GB2023/050085

§ 371 Date: Jul. 18, 2024

(30) Foreign Application Priority Data
Jan. 19, 2022 (GB) 2200676.1

(51) Int. Cl. C04B 14/06; C01B 33/193; C01F 5/24; C04B 14/26; C04B 28/04; C04B 111/00

(52) U.S. Cl. CPC C04B 14/06; C01B 33/193; C01F 5/24; C04B 14/26; C04B 28/04; C01P 2004/03; C04B 2111/00017

(57) ABSTRACT

Described herein are silica supplementary cementitious materials, composite cements and processes for their preparation. Also described herein are processes for preparing a composite cement comprising cement (e.g. Portland cement), a silica material (e.g. as an SCM), and optionally a carbonate material (e.g. as a filler), wherein said processes include the preparation of the silica material.

### TECHNICAL FIELD

The present disclosure is related to silica supplementary cementitious materials, processes for preparing these, and carbon capture and storage (CCS) processes, including for preparing reduced carbon composite cements comprising the silica materials.

### BACKGROUND OF THE INVENTION

The cement industry is responsible for 5-8% of the worlds anthropogenic carbon emissions. The manufacture of Portland cement produces about 800 kg CO₂/t Portland cement. Of this, approximately 60% is carbon dioxide released during the calcination of the raw materials which cannot be avoided through the use of renewable energies. The global demand for Portland cement can be reduced through the use of supplementary cementitious materials (SCMs). SCMs are materials with lower associated carbon emissions than Portland cement, that are blended with the cement to reduce the net carbon emission. SCMs usually contribute to the properties of cements and concretes through hydraulic and/or pozzolanic activity. Current commercial SCMs include fly ash, ground blast-furnace slag, and calcined clay. While these SCMs have lower associated carbon emissions than Portland cement, they still emit CO₂ when produced. Additionally, fly ash and ground blast-furnace slag have limited supplies—and these are likely to reduce further as less coal is burned and more steel is recycled, respectively.

There is a need for SCMs prepared by processes having reduced or negative carbon emissions, to enable the production of reduced carbon, carbon neutral, or carbon negative composite cements.

### SUMMARY OF THE INVENTION

Described herein are processes for preparing a composite cement comprising cement (e.g. Portland cement), a silica material (e.g. as an SCM), and optionally a carbonate material (e.g. as a filler), wherein said processes include the preparation of the silica material. In preparing the silica material, a metal salt is also obtained, which may be carbonated, for example in order to sequester CO₂ and thereby capture carbon emissions from industrial processes, such as cement production. Accordingly, a reduced carbon composite cement, a carbon zero composite cement, or even a carbon negative composite cement may be obtained by processes of the present invention. Advantageously, the present invention may provide a means of carbon capture and storage from industrial sources including, but not limited to, cement production. The present invention therefore may reduce the carbon emissions from many essential industrial processes.

According to a first aspect of the present invention there is provided a process for preparing a composite cement comprising a silica material, cement, and optionally a carbonate material; wherein the process comprises the steps:
a) preparing the silica material by:
i) contacting a metal silicate material with an aqueous acid to form a mixture comprising a silica component and a metal salt component;
ii) extracting the silica component from the metal salt component, to obtain the silica material, wherein the extraction comprises contacting the mixture with an organic solvent and separating the silica component from the metal salt component; or wherein the extraction comprises separating the silica component from the metal salt component; and washing the silica component with water, followed by an organic solvent;
b) carbonating the metal salt component to produce a carbonate material; and
c) blending the silica material, cement, and optionally a carbonate material to obtain the composite cement.

The cement may be Portland cement. The composite cement may comprise a silica material, cement, and a carbonate material; and step c) may comprise blending the silica material, cement, and a carbonate material to obtain the composite cement. The composite cement may comprise carbonate material obtained in step b). The composite cement may further comprise a further supplementary cementitious material such as calcareous fly ash, ground granulated blast furnace slag, calcined clays, or a combination thereof; and wherein step c) further comprises blending the further supplementary cementitious material.

The composite cement may comprise at least about 60 w/w % silica material relative to the total weight of the non-cement components in the composite cement. The composite cement may comprise at least about 60 w/w %, optionally at least about 70%, optionally at least about 80%, optionally at least about 90% by weight silica material relative to the total weight of the non-cement components in the composite cement. The composite cement may comprise at most about 40%, optionally at most about 30%, optionally at most about 20%, optionally at most about 10% by weight of carbonate material relative to the total weight of the non-cement components in the composite cement.

The composite cement may comprise at least about 60%, optionally at least about 70%, optionally at least about 80%, optionally at least about 90% by weight of silica material relative to the total weight of the silica material and the carbonate material. The composite cement may comprise at most about 40%, optionally at most about 30%, optionally at most about 20%, optionally at most about 10% by weight of carbonate material relative to the total weight of the silica material and the carbonate material.

The composite cement may comprise at most about 20 w/w % carbonate material relative to the total weight of the composite cement; optionally at most about 15 w/w %, optionally at most about 10 w/w %, optionally at most about 5 w/w % relative to the total weight of the composite cement. The composite cement may comprise from about 20 w/w % to about 60 w/w % carbonate material relative to the total weight of the composite cement; optionally from about 20 w/w % to about 55 w/w %, optionally from about 20 w/w % to about 50 w/w % relative to the total weight of the composite cement. The composite cement may not contain carbonate material. The composite cement may comprise at least about 5%, optionally at least about 10%, optionally at least about 15%, optionally at least about 20%, optionally at least about 25%, optionally at least about 30% of silica material by weight relative to the total weight of the composite cement; optionally wherein the composite cement comprises about 35 w/w % of silica material relative to the total weight of the composite cement. The composite cement may comprise at least about 20%, optionally at least about 30%, optionally at least about 40%, optionally at least about 50%, optionally at least about 60% of cement by weight relative to the total weight of the composite cement; optionally wherein the composite cement comprises about 65 w/w % of cement relative to the total weight of the composite cement. The composite cement may comprise at most about 35 w/w % of silica material and at least about 65 w/w % cement, relative to the total weight of the composite cement. The composite cement may comprise about 35 w/w % of silica material and about 65 w/w % cement, relative to the total weight of the composite cement. The composite cement comprises about 33 w/w % cement (e.g. Portland cement), about 18% silica material, and about 49% carbonate material.

The metal silicate material may be a mineral. The metal silicate material may be a material comprising an alkali earth silicate (e.g. magnesium silicate, calcium silicate), an alkali earth aluminosilicate, hydroxysilicate, or a combination thereof. The metal silicate material may be olivine. The metal silicate material may be basaltic rock. The metal silicate material may be waste cement paste.

The aqueous acid used in step i) may be a mineral acid. The aqueous acid used in step i) may be aqueous H₂SO₄ or HCl. The aqueous acid may comprise aq. H₂SO₄ and the metal salt component may comprise metal sulfate salts. The aqueous acid may comprise aq. HCl and the metal salt component may comprise metal chloride salts.

There may be a stoichiometric excess of metal silicate material with respect to the aqueous acid, during step i). The molar ratio of metal silicate to acid may be from about 0.5:1 to about 2:1, optionally from about 1.25:1 to about 1.5:1. The process may further comprise grinding the metal silicate material prior to contacting it with aqueous acid.

The extraction of step ii) may comprise contacting the mixture with an organic solvent and separating the silica component from the metal salt component. The extraction of step ii) may comprise separating the silica component from the metal salt component; and washing the silica component with water, followed by an organic solvent. The organic solvent used in the extraction step may be an alcohol, such as isopropanol, ethanol, methanol, or a combination thereof. Step ii) may further comprise the addition of a base, such as magnesium oxide, ammonium hydroxide or ammonia, prior to separating the silica component from the metal salt component. Step ii) may further comprise drying the silica component (e.g. after washing). Step ii) may further comprise milling of the silica component.

The silica material may comprise amorphous silica; and optionally further comprise metal silicate, such as unreacted metal silicate and/or partially reacted metal silicate. The silica material may comprise at least about 50%, optionally at least about 60%, optionally at least about 70%, optionally at least about 80%, optionally at least about 85% amorphous silica by weight relative to the total weight of the silica material. The silica material may comprise at most about 50%, optionally at most about 40%, optionally at most about 30%, optionally at most about 20% optionally at most about 15% metal silicate by weight relative to the total weight of the silica material.

The carbonation in step b) may comprise contacting the metal salt component with carbon dioxide and a base. The base used in step b) may be ammonium hydroxide or ammonia. The pH may be adjusted to from about 9.5 to about 10 upon addition of the base and the carbon dioxide in step b). The carbonation in step b) may be carried out using an industrial flue gas having at least about 5% CO₂ by volume. The industrial flue gas may be obtained as a byproduct of cement production.

Prior to the carbonation, base may be added to the metal salt component to adjust the pH to from about 3 to about 8 (e.g. about 3 to about 7) and resulting precipitate is removed.

Following carbonation, the carbonate material may be isolated. The carbonate material may be washed. The carbonate material may be dried, for example by heating.

The process may further comprise an acid regeneration step, occurring after step b). The acid used in step i) may be obtained from the acid regeneration step. The base used in step ii) and/or in step b) may be obtained from the acid regeneration step.

According to a second aspect of the present invention there is provided a process for preparing a composite cement comprising a silica material, cement, and optionally a carbonate material; wherein the process comprises the steps:
a) preparing the silica material by:
i) contacting a metal silicate material with an aqueous acid to form a mixture comprising a silica component and a metal salt component;
ii) extracting the silica component from the metal salt component, to obtain the silica material; and
b) carbonating the metal salt component to produce a carbonate material;
c) blending the silica material, cement, and optionally a carbonate material to obtain the composite cement;
   wherein the composite cement comprises at least about 60 w/w % silica material relative to the total weight of the non-cement components in the composite cement.

The cement may be Portland cement. The composite cement may comprise a silica material, cement, and a carbonate material; and step c) may comprise blending the silica material, cement, and a carbonate material to obtain the composite cement. The composite cement may comprise carbonate material obtained in step b). The composite cement may further comprise a further supplementary cementitious material such as calcareous fly ash, ground granulated blast furnace slag, calcined clays, or a combination thereof; and wherein the blending step further comprises blending the further supplementary cementitious material.

The composite cement may comprise at least about 60 w/w %, optionally at least about 70%, optionally at least about 80%, optionally at least about 90% by weight silica material relative to the total weight of the non-cement components in the composite cement. The composite cement may comprise at most about 40%, optionally at most about 30%, optionally at most about 20%, optionally at most about 10% by weight of carbonate material relative to the total weight of the non-cement components in the composite cement. The composite cement may comprise at least about 70%, optionally at least about 80%, optionally at least about 90% by weight of silica material relative to the total weight of the silica material and the carbonate material. The composite cement may comprise at most about 40%, optionally at most about 30%, optionally at most about 20%, optionally at most about 10% by weight of carbonate material relative to the total weight of the silica material and the carbonate material.

The composite cement may comprise at most about 20 w/w % carbonate material relative to the total weight of the composite cement; optionally at most about 15 w/w %, optionally at most about 10 w/w %, optionally at most about 5 w/w % relative to the total weight of the composite cement. The composite cement may not contain carbonate material. The composite cement may comprise at least about 5%, optionally at least about 10%, optionally at least about 15%, optionally at least about 20%, optionally at least about 25%, optionally at least about 30% of silica material by weight relative to the total weight of the composite cement; optionally wherein the composite cement comprises about 35 w/w % of silica material relative to the total weight of the composite cement. The composite cement may comprise at least about 20%, optionally at least about 30%, optionally at least about 40%, optionally at least about 50%, optionally at least about 60% of cement by weight relative to the total weight of the composite cement; optionally wherein the composite cement comprises about 65 w/w % of cement relative to the total weight of the composite cement. The composite cement may comprise at most about 35 w/w % of silica material and at least about 65 w/w % cement, relative to the total weight of the composite cement. The composite cement may comprise about 35 w/w % of silica material and about 65 w/w % cement, relative to the total weight of the composite cement.

The metal silicate material may be a mineral. The metal silicate material may be a material comprising an alkali earth silicate (e.g. magnesium silicate, calcium silicate), an alkali earth aluminosilicate, hydroxysilicate, or a combination thereof. The metal silicate material may be olivine. The metal silicate material may be basaltic rock. The metal silicate material may be waste cement paste.

The aqueous acid used in step i) may be a mineral acid. The aqueous acid used in step i) may be aqueous H₂SO₄ or HCl. The aqueous acid may comprise aq. H₂SO₄ and the metal salt component may comprise metal sulfate salts. The aqueous acid may comprise aq. HCl and the metal salt component may comprise metal chloride salts.

There may be a stoichiometric excess of metal silicate material with respect to the aqueous acid, during step i). The molar ratio of metal silicate to acid may be from about 0.5:1 to about 2:1, optionally from about 1.25:1 to about 1.5:1. The process may further comprise grinding the metal silicate material prior to contacting it with aqueous acid.

The extraction of step ii) may comprise contacting the mixture with an organic solvent and separating the silica component from the metal salt component. The extraction of step ii) may comprise separating the silica component from the metal salt component; and washing the silica component with water, followed by an organic solvent. The organic solvent used in the extraction step may be an alcohol, such as isopropanol, ethanol, methanol, or a combination thereof. Step ii) may further comprise the addition of a base, such as magnesium oxide, ammonium hydroxide or ammonia, prior to separating the silica component from the metal salt component. Step ii) may further comprise drying the silica component (e.g. after washing). Step ii) may further comprise milling of the silica component.

The silica material may comprise amorphous silica; and optionally further comprise metal silicate, such as unreacted metal silicate and/or partially reacted metal silicate. The silica material may comprise at least about 50%, optionally at least about 60%, optionally at least about 70%, optionally at least about 80%, optionally at least about 85% amorphous silica by weight relative to the total weight of the silica material. The silica material may comprise at most about 50%, optionally at most about 40%, optionally at most about 30%, optionally at most about 20% optionally at most about 15% metal silicate by weight relative to the total weight of the silica material.

The carbonation in step b) may comprise contacting the metal salt component with carbon dioxide and a base. The base used in step b) may be ammonium hydroxide or ammonia. The pH may be adjusted to from about 9.5 to about 10 upon addition of the base and the carbon dioxide in step b). The carbonation in step b) may be carried out using an industrial flue gas having at least about 5% CO₂ by volume. The industrial flue gas may be obtained as a byproduct of cement production.

Prior to the carbonation, base may be added to the metal salt component to adjust the pH to from about 3 to about 8 (e.g. about 3 to about 7) and resulting precipitate is removed. Following carbonation, the carbonate material may be isolated. The carbonate material may be washed. The carbonate material may be dried, for example by heating.

The process may further comprise an acid regeneration step, occurring after step b). The acid used in step i) may be obtained from the acid regeneration step. The base used in step ii) and/or in step b) is obtained from the acid regeneration step.

Features of the process according to the second aspect may be as defined in relation to the first aspect of the present invention, and vice-versa, mutatis mutandis.

According to a third aspect of the present invention there is provided a process for preparing a silica material comprising the steps:
i) contacting a metal silicate material with an aqueous acid to form a mixture comprising a silica component and a metal salt component;
ii) extracting the silica component from the metal salt component, to obtain the silica material;
   wherein the extraction comprises contacting the mixture with an organic solvent and separating the silica component from the metal salt component; or
   wherein the extraction comprises separating the silica component from the metal salt component; and washing the silica component with water, followed by an organic solvent.

The metal silicate material may be a mineral. The metal silicate material may be a material comprising an alkali earth silicate (e.g. magnesium silicate, calcium silicate), an alkali earth aluminosilicate, hydroxysilicate, or a combination thereof. The metal silicate material may be olivine. The metal silicate material may be basaltic rock. The metal silicate material may be waste cement paste.

The aqueous acid used in step i) may be a mineral acid. The aqueous acid used in step i) may be aqueous H₂SO₄ or HCl. The aqueous acid may comprise aq. H₂SO₄ and the metal salt component may comprise metal sulfate salts. The aqueous acid may comprise aq. HCl and the metal salt component may comprise metal chloride salts.

There may be a stoichiometric excess of metal silicate material with respect to the aqueous acid, during step i). The molar ratio of metal silicate to acid may be from about 0.5:1 to about 2:1, optionally from about 1.25:1 to about 1.5:1. The process may further comprise grinding the metal silicate material prior to contacting it with aqueous acid.

The extraction of step ii) may comprise contacting the mixture with an organic solvent and separating the silica component from the metal salt component. The extraction of step ii) may comprise separating the silica component from the metal salt component; and washing the silica component with water, followed by an organic solvent. The organic solvent used in the extraction step may be an alcohol, such as isopropanol, ethanol, methanol, or a combination thereof. Step ii) may further comprise the addition of a base, such as magnesium oxide, ammonium hydroxide or ammonia, prior to separating the silica component from the metal salt component. Step ii) may further comprise drying the silica component (e.g. after washing). Step ii) may further comprise milling of the silica component.

The silica material may comprise amorphous silica; and optionally further comprise metal silicate, such as unreacted metal silicate and/or partially reacted metal silicate. The silica material may comprise at least about 50%, optionally at least about 60%, optionally at least about 70%, optionally at least about 80%, optionally at least about 85% amorphous silica by weight relative to the total weight of the silica material. The silica material may comprise at most about 50%, optionally at most about 40%, optionally at most about 30%, optionally at most about 20% optionally at most about 15% metal silicate by weight relative to the total weight of the silica material.

The process according to the third aspect may further comprise a step of carbonating the metal salt component, to produce a carbonate material. The carbonation may comprise contacting the metal salt component with carbon dioxide and a base. The base used in the carbonating step may be ammonium hydroxide or ammonia. The pH may be adjusted to from about 9.5 to about 10 upon addition of the base and the carbon dioxide in the carbonating step. The carbonation may be carried out using an industrial flue gas having at least about 5% CO₂ by volume. The industrial flue gas may be obtained as a byproduct of cement production. Prior to the carbonation, base may be added to the metal salt component to adjust the pH to from about 3 to about 8 (e.g. about 3 to about 7) and resulting precipitate may be removed. After carbonation, the carbonate material may be isolated. The carbonate material may be washed. The carbonate material may be dried, for example by heating.

The process according to the third aspect may further comprise an acid regeneration step, occurring after the carbonation step. The acid used in step i) may be obtained from the acid regeneration step. The base used in the carbonating step may be obtained from the acid regeneration step.

Features of the process according to the third aspect may be as defined in relation to the first or second aspects of the present invention, mutatis mutandis.

According to a fourth aspect of the present invention there is provided a use of an organic solvent to extract a silica component from a mixture comprising a metal salt component and a silica component, optionally wherein the mixture is formed by contacting a metal silicate material with an aqueous acid. Features of the fourth aspect may be as defined in relation to the first, second or third aspects of the present invention, mutatis mutandis.

According to a fifth aspect of the present invention there is provided a silica material obtainable by the process of the third aspect. The silica material may be as defined in relation to the first, second or third aspects of the present invention, mutatis mutandis.

According to a sixth aspect of the present invention there is provided a use of the silica material according to the fifth aspect in a composite cement. The silica material may be as defined in relation to the first, second or third aspects of the present invention, mutatis mutandis.

According to a seventh aspect of the present invention there is provided a carbonate material obtainable by the process according to the third aspect of the invention. The carbonate material may be as defined in relation to the first, second or third aspects of the present invention, mutatis mutandis.

According to an eighth aspect of the present invention there is provided a use of the carbonate material according to the seventh aspect for storage of carbon dioxide. The carbonate material may be as defined in relation to the first, second or third aspects of the present invention, mutatis mutandis.

According to a ninth aspect of the present invention there is provided a composite cement obtainable by the process according to the first or second aspects of the present invention. The composite cement may be as defined in relation to the first or second aspects of the present invention, mutatis mutandis.

According to a tenth aspect of the present invention there is provided a composite cement comprising the silica material according to the fifth aspect, cement, and optionally a carbonate material. The composite cement, silica material, cement and carbonate material may be as defined in relation to the first, second or third aspects of the present invention, mutatis mutandis.

According to an eleventh aspect of the present invention there is provided a composite cement comprising cement, the silica material according to the fifth aspect, and the carbonate material according to the seventh aspect. The composite cement, silica material, cement and carbonate material may be as defined in relation to the first, second or third aspects of the present invention, mutatis mutandis.

According to a twelfth aspect of the present invention there is provided a composite cement comprising a silica material, cement (e.g. Portland), and optionally a carbonate material, wherein the composite cement comprises at least about 60 w/w % silica material relative to the total weight of the non-cement components (e.g. relative to the total weight of silica material and carbonate material) in the composite cement, and at least about 5% silica material relative to the total weight of the composite cement.

The composite cement may further comprise a further supplementary cementitious material such as calcareous fly ash, ground granulated blast furnace slag, calcined clays, or a combination thereof. The composite cement may comprise at least about 70%, optionally at least about 80%, optionally at least about 90% by weight silica material relative to the total weight of the non-cement components in the composite cement. The composite cement may comprise at most about 40%, optionally at most about 30%, optionally at most about 20%, optionally at most about 10% by weight of carbonate material relative to the total weight of the non-cement components in the composite cement. The composite cement may comprise at least about 60%, optionally at least about 70%, optionally at least about 80%, optionally at least about 90% by weight of silica material relative to the total weight of the silica material and the carbonate material. The composite cement may comprise at most about 40%, optionally at most about 30%, optionally at most about 20%, optionally at most about 10% by weight of carbonate material relative to the total weight of the silica material and the carbonate material. The composite cement may comprise at most about 20 w/w % carbonate material relative to the total weight of the composite cement; optionally at most about 15 w/w %, optionally at most about 10 w/w %, optionally at most about 5 w/w % relative to the total weight of the composite cement. The composite cement may not contain carbonate material. The composite cement may comprise at least about 10%, optionally at least about 15%, optionally at least about 20%, optionally at least about 25%, optionally at least about 30% of silica material by weight relative to the total weight of the composite cement; optionally wherein the composite cement comprises about 35 w/w % of silica material relative to the total weight of the composite cement. The composite cement may comprise at least about 20%, optionally at least about 30%, optionally at least about 40%, optionally at least about 50%, optionally at least about 60% of cement by weight relative to the total weight of the composite cement; optionally wherein the composite cement comprises about 65 w/w % of cement relative to the total weight of the composite cement. The composite cement may comprise at most about 35 w/w % of silica material and at least about 65 w/w % cement, relative to the total weight of the composite cement. The composite cement may comprise about 35 w/w % of silica material and about 65 w/w % cement, relative to the total weight of the composite cement. The composite cement may comprise about 33 w/w % cement (e.g. Portland cement), about 18% silica material, and about 49% carbonate material.

The silica material may comprise amorphous silica and optionally further comprises metal silicate, such as unreacted metal silicate and/or partially reacted metal silicate. The silica material may comprise at least about 50%, optionally at least about 60%, optionally at least about 70%, optionally at least about 80%, optionally at least about 85% amorphous silica by weight relative to the total weight of the silica material. The silica material comprises at most about 50%, optionally at most about 40%, optionally at most about 30%, optionally at most about 20% optionally at most about 15% metal silicate by weight relative to the total weight of the silica material.

The composite cement, silica material, cement, and carbonate material according to the twelfth aspect of the present invention may be as defined in relation to the first or second aspects of the present invention, mutatis mutandis.

Also disclosed is a process, use, silica material, carbonate material or composite cement as substantially described herein, with reference to the accompanying drawings. The process, use, silica material, carbonate material or composite cement may be as defined in relation to any of the first to twelfth aspects of the present invention.

### SUMMARY OF FIGURES

FIG. 1 shows an exemplary process for producing a net carbon negative SCM and a reduced carbon (e.g. carbon zero) composite cement. The exemplary process includes steps to produce silica material from a metal silicate material such as olivine, carbonisation of the metal salt component such as magnesium salt, and acid regeneration. The process steps within the long dash lines represent an exemplary process according to the first and second aspects of the present invention. The process steps within the short dash lines represent an exemplary process according to the third aspect of the present invention.

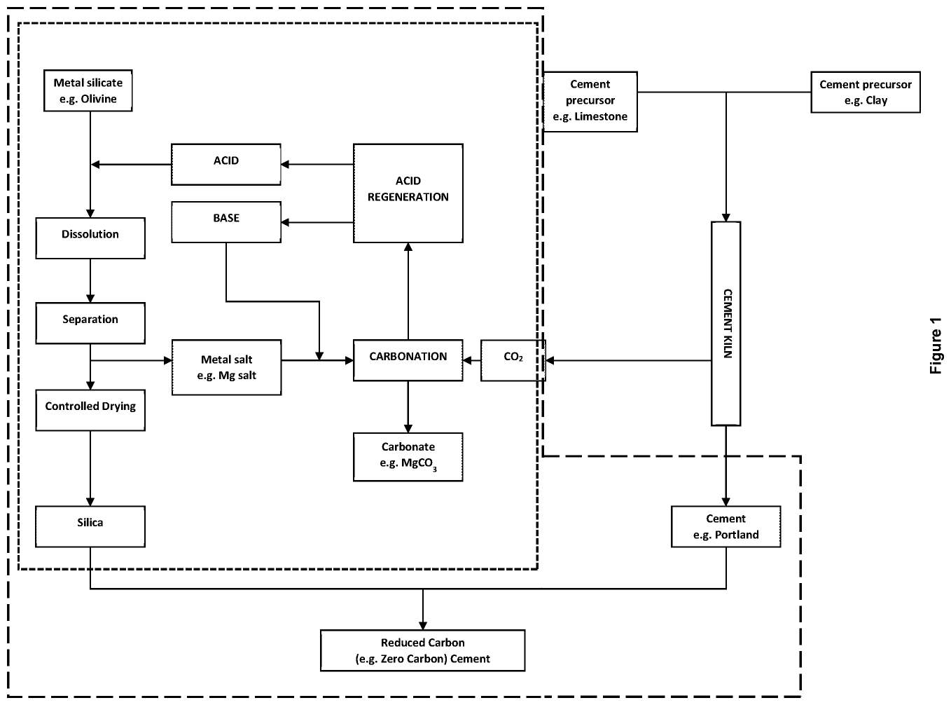

FIG. 2 shows scanning electron microscope (SEM) images of ground silica material obtained according to a process of the present invention (Example 1). Top: Silica agglomerates (circled) cover the surface of a larger olivine particle. Bottom: Particles of partially reacted olivine surrounded by smaller (1 micron) silica agglomerates can be seen.

FIG. 3 shows the pozzolanic activity of silica material (obtained according to Example 2) compared to fly ash (FA), determined using a saturated lime test.

### DEFINITIONS

The term “cement” refers to a substance that sets, hardens, and adheres to other materials to bind them together, and that is set by hydraulic or pozzolanic reactions or a combination thereof. Cement may comprise calcium silicates.

The term “Portland cement” refers to a hydraulic cement which consists essentially of hydraulic calcium silicates, for example at least two-thirds by mass of calcium silicates. Portland cement may be as defined in ASTM C150/C150M-21 (incorporated by reference in its entirety). Portland cement may be as defined in European Standard EN 197-1:2011 (incorporated by reference in its entirety), for example CEM I, which comprises Portland cement and up to 5% of minor additional constituents.

The term “supplementary cementitious material” (SCM) refers to materials that, when blended with cement, contribute to the properties of the cement through hydraulic or pozzolanic activity. Hydraulic SCMs react with water (with or without the present of cement) to form materials with cementitious properties (i.e. strength-bearing). Pozzolanic SCMs react with alkali metal hydroxides, such as calcium hydroxide, present in hydrated cement paste to form materials with cementitious properties. The alkali metal hydroxides, such as calcium hydroxide, may form during hydration of the cement and/or may be added to the cement in the form of an alkali activator. For example, a pozzolanic SCM may be a pozzolan as defined in ASTM C125-07 (incorporated by reference in its entirety), namely “a siliceous and aluminous material which, in itself, possesses little or no cementitious value but which will, in finely divided form in the presence of moisture, react chemically with calcium hydroxide at ordinary temperature to form compounds possessing cementitious properties”. Examples of SCMs include fly ash, such as siliceous (i.e. silica-rich) or calcareous (i.e. calcium-rich) fly ash; ground granulated blast furnace slag; natural pozzolans such as calcined clays, shales or sedimentary rocks; burnt shale. These materials may be as defined in EN197-1:2011 (incorporated by reference in its entirety).

A “reduced carbon” material (e.g. a reduced carbon composite cement) refers to a material (e.g. composite cement) in which the net carbon emissions resulting from the manufacture of the material (e.g. composite cement) are lower than in previously known manufacturing methods (e.g. previously known methods for making composite cements, such as cements comprising fillers and/or SCMs). A “carbon zero” or “carbon neutral” material (e.g. a carbon zero or carbon neutral composite cement) refers to a material (e.g. a composite cement) in which the net carbon emissions from its manufacture are substantially zero. A “carbon negative” material (e.g. a carbon negative composite cement) refers to a material (e.g. a composite cement) in which the net carbon emissions resulting from its manufacture are negative.

Throughout the description and claims of this specification, the words “comprise” and “contain” and variations of the words, for example “comprising” and “comprises”, mean “including but not limited to”, and are not intended to (and do not) exclude other components. In any of the embodiment described herein, reference to “comprising” also encompasses “consisting essentially of”.

### DETAILED DESCRIPTION

Described herein are processes for preparing a composite cement comprising cement, a silica material (e.g. as an SCM), and optionally a carbonate material (e.g. as a filler). These processes include the preparation of the silica material from a metal silicate. In obtaining the silica material, a metal salt is also obtained, which may be carbonated, for example in order to sequester CO₂ and thereby capture carbon emissions from industrial processes, such as cement production. Accordingly, a reduced carbon composite cement, a carbon zero composite cement or even a carbon negative composite cement may be obtained by processes of the present invention. Advantageously, the present invention may provide a means of carbon capture and storage from industrial sources including, but not limited to, cement production. The present invention therefore may reduce the carbon emissions from many essential industrial processes.

According to a first aspect of the present invention there is provided a process for preparing a composite cement comprising a silica material, cement (e.g. Portland cement), and optionally a carbonate material; wherein the process comprises the steps:
a) preparing the silica material by:
i) contacting a metal silicate material with an aqueous acid to form a mixture comprising a silica component and a metal salt component;
ii) extracting the silica component from the metal salt component, to obtain the silica material; wherein the extraction comprises contacting the mixture with an organic solvent and separating the silica component from the metal salt component; or wherein the extraction comprises separating the silica component from the metal salt component, and washing the silica component with water, followed by an organic solvent; and
b) carbonating the metal salt component to produce a carbonate material; and
c) blending the silica material, cement (e.g. Portland cement), and optionally a carbonate material to obtain the composite cement.

According to a second aspect of the present invention there is provided a process for preparing a composite cement comprising a silica material, cement (e.g. Portland cement), and optionally a carbonate material; wherein the process comprises the steps:
a) preparing the silica material by:
i) contacting a metal silicate material with an aqueous acid to form a mixture comprising a silica component and a metal salt component;
ii) extracting the silica component from the metal salt component, to obtain the silica material; and
b) carbonating the metal salt component to produce a carbonate material; and
c) blending the silica material, cement (e.g. Portland cement), and optionally a carbonate material to obtain the composite cement;
wherein the composite cement comprises at least about 60 w/w % silica material relative to the total weight of the non-cement components in the composite cement.

The term “non-cement components” refers to all components present in the composite cement other than the cement itself (i.e. the cement added in step c). For example, the non-cement components may consist of silica material. The non-cement components may consist of silica material and carbonate material. The non-cement components may comprise silica material, carbonate material, and other components such as additional fillers and/or supplementary cementitious materials. The non-cement components may comprise silica material and other components such as additional fillers and/or supplementary cementitious materials.

According to a third aspect of the present invention there is provided a process for preparing a silica material comprising the steps:
i) contacting a metal silicate material with an aqueous acid to form a mixture comprising a silica component and a metal salt component;
ii) extracting the silica component from the metal salt component, to obtain the silica material;
wherein the extraction comprises contacting the mixture with an organic solvent and separating the silica component from the metal salt component; or
wherein the extraction comprises separating the silica component from the metal salt component, and washing the silica component with water, followed by an organic solvent.

The metal silicate material described herein may comprise a mineral, including but not limited to an orthosilicate (e.g. olivine), inosilicate, phyllosilicate (e.g. serpentine), and tectosilicate, and combinations thereof. The metal silicate material may comprise an alkali earth silicate (e.g. magnesium silicate, calcium silicate, or a combination thereof), an aluminosilicate (e.g. alkali earth aluminosilicate), hydroxysilicate, or a combination thereof.

The metal silicate material may comprise a magnesium silicate. The metal silicate material may comprise olivine. Olivine is a magnesium iron silicate with the chemical formula (Mg²⁺,Fe²⁺)₂SiO₄. The metal silicate material may be a rock, for example basaltic rock or feldspar.

The metal silicate material may comprise waste cement paste (e.g. waste Portland cement paste). The term “waste cement paste” or “waste hydrated cement paste”, refers to the leftover hydrated cement paste recovered from demolished concrete structures once the large aggregate has been separated, by either chemical or mechanical means. Waste cement paste contains calcium silicate and can therefore be contacted with aqueous acid to obtain silica material, according to the processes of the invention. The processes of the invention therefore provide a means for recycling waste cement paste. If waste cement paste is used as the starting material in the processes of the present invention, silica material and calcium salts are obtained following steps i) and ii). After carbonation, calcium carbonate is obtained. This can be recombined into a cement as filler, where it also acts as a stable carbon capture and storage (CCS) material. Calcium carbonate can also be used (or further processed) in other forms as a stable CCS material. Waste cement paste may be pre-treated prior to use in step i) of the processes of the present invention. For example, the waste cement paste may be ground, for example as a powder, and/or calcined prior to use in step i) of the processes of the present invention.

The skilled person will appreciate that the metal of the metal salt component will correspond to the metal of the metal silicate material. For example, depending on the metal silicate used, the metal salt component may comprise magnesium, iron, aluminium or calcium salts or a combination thereof. For example, a metal silicate material comprising an alkali earth silicate will result in a metal salt component comprising alkali earth metal salts. For example, if the metal silicate material is olivine, the metal salt component will comprise magnesium and iron salts.

The silica component described herein comprises amorphous silica (e.g. amorphous precipitated silica). Amorphous precipitated silica (APS) is an amorphous form of silica (silicon dioxide, SiO₂) that is produced by precipitation from a solution containing dissolved silica species. This may also be termed reactive silica or reactive silicon dioxide (which may be as defined in EN 197-1). Amorphous silica, such as APS, is a pozzolanic material.

The silica component may also comprise unreacted metal silicate. “Unreacted metal silicate” may refer to starting material from step i) that has not reacted with the aqueous acid (i.e. has not been digested by the aqueous acid). Unreacted metal silicate is not pozzolanic and, if incorporated into a composite cement, has the effect of an inert filler. Fillers may act to improve workability of composite cements and concretes, and accelerate the hydration of reactive components in cements.

The silica component may also comprise partially reacted metal silicate. “Partially reacted metal silicate” may refer to a metal silicate particle that has not been fully digested by the aqueous acid, so that only the outer part of the metal silicate particle has been digested. Partially reacted particles have a silica-rich surface layer, due to the preferential extraction of metal ions and/or additional amorphous silica from the mixture deposited in the surface of the particle. These may be referred to as metal silicate particles coated in amorphous silica (e.g. amorphous precipitated silica).

Partially reacted metal silicate particles may also be referred to as “engineered reactive filler”. As opposed to a typical filler material such as calcium carbonate, which is inert in a cement system, partially reacted metal silicate particles can act as a filler-like particle (in the form of unreactive metal silicate) and also as a reactive pozzolanic material (due to the surface amorphous silica), Therefore, these particles give benefits as both a filler and a pozzolanic material. When present in a composite cement, partially reacted metal silicate particles may act to improve workability (as with normal fillers) without creating a weaker interfacial transition zone with the calcium silicate hydrate gels in cement matrices, as is common for normal fillers.

The silica component may comprise additional components, depending on the metal silicate used. For example, if the metal silicate comprises alkali earth aluminosilicates, the silica component may further comprise alumina and/or aluminosilicate. The silica material described herein comprises amorphous silica (e.g. amorphous precipitated silica, APS). The silica material may also comprise unreacted metal silicate.

The silica material may also comprise partially reacted metal silicate. The silica material may comprise additional components, depending on the metal silicate used, as described herein.

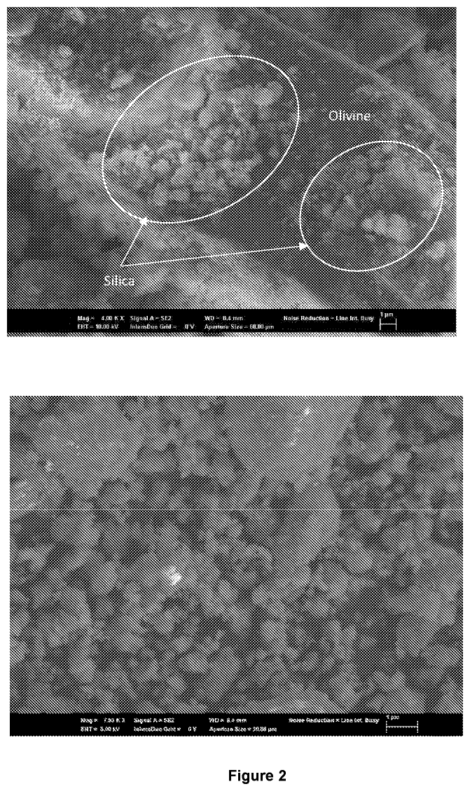

FIG. 2 provides SEM images of silica material. In these images, silica material comprising agglomerated silica (top image), unreacted olivine particles (top image), partially reacted olivine (bottom image) can be seen.

### Digestion (Step i)

Step i), according to the processes of the present invention, comprises contacting a metal silicate material with an aqueous acid to form a mixture (e.g. a slurry) comprising a silica component and a metal salt component. This contacting step refers to the digestion of the metal silicate (e.g. olivine), using an aqueous acid. The digestion results in formation of a silica component and a metal salt component. Digestion may be incomplete, such that unreacted and/or partially reacted metal silicate remains in the mixture.

During the contacting step, the metal silicate material and acid form a mixture, for example a slurry. The metal silicate material may dissolve in the acid. The mixture may be stirred, for example continuously stirred throughout this step. The mixture may be heated, for example to at least about 50° C., optionally at least about 60° C., optionally at least about 70° C., optionally at least about 80° C., optionally at least about 90° C. The mixture may be heated to at most 100° C. The acid may be pre-heated prior to contacting with the metal silicate material (e.g. to at least about 40° C., optionally at least about 50° C., optionally at least about 60° C.). The heating may be for at least about 1 minute, optionally at least about minutes, optionally at least about 10 minutes, optionally at least about 30 minutes, optionally at least about 60 minutes, optionally at least about 90 minutes. The mixture may be subjected to pressure above normal atmospheric pressure (about 1 bar), for example to a pressure of greater than about 1 bar, optionally at most about 50 bar. The mixture may be heated to at most about 150° C., optionally at most about 200° C., optionally at most about 250° C., optionally at most about 300° C.

The metal silicate material may be provided in the form of granules or as a powder, preferably as a powder. The skilled person will appreciate that the size of the granules or powder will affect the rate of the dissolution. The metal silicate material may have an average particle size of at most about 1 mm, optionally at most about 500 μm, optionally at most about 200 μm. The metal silicate material may have an average particle size of from about 40 to about 150 μm. As used herein, average particle size refers to the modal value of a particle size distribution, for example as measured by dynamic light scattering using a light scattering detector. The average particle size may be measured using laser diffraction with liquid dispersion. The process may comprise grinding the metal silicate material prior to contacting it with aqueous acid.

The skilled person will appreciate that the metal of the metal salt component will correspond to the metal of the metal silicate material used. For example, when the metal silicate material comprises an alkali earth (e.g. magnesium) silicate, the metal salt component comprises alkali earth (e.g. magnesium) salts. For example, when the metal silicate material comprises olivine, (Mg²⁺,Fe²⁺)₂SiO₄, the metal salt component comprises magnesium and iron salts.

The aqueous acid may be a mineral acid or an organic acid. The aqueous acid may be selected from the group consisting of HF, HCl, HBr, HI, H₂SO₄, HNO₃, H₃PO₄, chromic acid, H₂CO₃, acetic acid, citric acid, formic acid, gluconic acid, lactic acid, oxalic acid, tartaric acid, ascorbic acid, and Meldrum's acid. The aqueous acid may be aqueous HCl or H₂SO₄. The aqueous acid may be aqueous H₂SO₄. Advantageously, increased concentration of product may be obtained when using H₂SO₄ rather than HCl. The higher maximum concentration of industrial H₂SO₄ (compared to industrial HCl) may allow for an increased concentration of reactants and increased yield.

The skilled person will appreciate that the stoichiometry of the reaction occurring during step i) will differ depending on whether mono-, di- or tri- basic acids are used, meaning that the amount of acid relative to metal silicate will need to be adjusted according to the acid used. Exemplary reaction equations are shown below for mono-, di- and tri- basic acids, where the metal silicate is magnesium silicate.

Mono: Mg₂SiO₄+2HX->SiO₂+2MgX₂₊H₂O

Di: Mg₂SiO₄+2H₂X->SiO₂+2MgX+2H₂O

Tri: Mg₂SiO₄+4/3H₃X->SiO₂+2/3Mg₃X₂+2H₂O

The skilled person will appreciate that the anion of the metal salt in the metal salt component will correspond to the anion of the acid used. For example, when the aqueous acid comprises aq. HCl, the metal salt component comprises metal chloride salts. When the aqueous acid comprises aq. H₂SO₄ and the metal salt component comprises metal sulfate salts.

During step i), there may be a molar ratio of metal silicate material to acid of about 0.5:1 to about 2:1, optionally from about 1:1 to about 2:1 or from about 0.5:1 to about 1.5:1. There may be a stoichiometric excess of metal silicate material with respect to the aqueous acid, during step i). For example, there may be a molar ratio of metal silicate to acid of greater than 1:1. There may be a stoichiometric ratio of from about 1.1:1 to about 2:1, optionally from about 1.25:1 to about 1.5:1. A stoichiometric excess of the metal silicate material may increase the amount of partially reacted metal silicate in the mixture (and in the silica component) following step i). A stoichiometric excess of metal silicate material may increase pH by neutralising excess acid, thus facilitating silica precipitation.

### Extraction (Step ii)

The extraction may comprise contacting the mixture (e.g. slurry) with an organic solvent and separating the silica component from the metal salt component. The extraction may comprise separating the silica component from the metal salt component, and washing the silica component with water, followed by an organic solvent.

The organic solvent may be a protic or aprotic solvent (or a combination thereof), preferably a protic solvent. The organic solvent is preferably an alcohol, such as isopropanol, ethanol, methanol, or a combination thereof. The use of an organic solvent is advantageous, as it prevents silica particles from agglomerating. At high concentrations of silica (as may be obtained in the processes of the present invention), the entire silica network may solidify and gel, for example if left to stand for a prolonged period (e.g. 24 hours). If this occurs, any gel structures may be disrupted to form small particles, for example by applying a shear force e.g. using high shear rate mixing. Once the structure has been broken down, the organic solvent also ensures the silica particles remain small and do not reagglomerate.

Moreover, contacting the mixture with an organic solvent may enable easy separation of the silica component and the metal salt component, through the formation of a silica-rich organic phase (e.g. a suspension of silica component in the organic solvent) and an aqueous metal salt-rich phase (where the organic solvent has lower polarity than the aqueous phase). For example, contacting the mixture with isopropanol may cause the mixture to separate into two phases; an organic phase comprising silica component in the upper portion of the reaction vessel, and an aqueous phase comprising metal salt component in the lower portion of the reaction vessel. The two phases can be easily separated by drawing the desired phase from the top or bottom of the vessel respectively. The skilled person will appreciate that the identity of the upper and lower phases in the vessel will depend on the relative densities of each phase.

The organic layer (comprising the silica component) may be dried, to obtain the silica material. The organic solvent may be recovered, for example so that it can be reused in the process. Step ii) may further comprise washing the silica material. The washing may comprise washing with water (e.g. distilled water). The washing may further comprise washing with an organic solvent (such as an organic solvent having lower polarity than water, for example an alcohol).

A base may be contacted with the mixture obtained following step i). Any suitable base may be used. The base may be an inorganic base such as magnesium oxide (MgO), ammonia, or ammonium hydroxide (NH₄OH). The base may be the same as the base that may be used in the carbonation step. The presence of a base may increase pH by neutralising excess acid, thus facilitating silica precipitation. If the base is MgO, this may react with residual acid in the mixture to produce magnesium salts that would form part of the metal salt component.

For example, the silica component may be extracted from the metal salt component by precipitation of the silica component from a solution comprising the metal salt component. For example, a base (e.g. MgO or NH₄OH) may be added to the mixture (e.g. to obtain a pH of from about 4 to about 5, optionally from about 4.5 to about 5.0). The increase in pH may cause the silica component to precipitate. The precipitated silica component may be separated from the solution comprising the metal salt component (e.g. by filtering), to obtain the silica material. The extraction may also comprise a step to remove any undissolved solids that may be present in the mixture, prior to precipitation of the silica component. For example, following step i), the mixture may be left to stand (e.g. for at least about 30 minutes, optionally at least about 60 minutes). This may allow any undissolved solids to settle. The resulting supernatant solution (comprising the metal salt component and the silica component) may be decanted from undissolved solids. Base (e.g. MgO or NH₄OH) may then be added to the decanted solution, to cause the silica component to precipitate. The precipitated silica component may be separated from the solution comprising the metal salt component (e.g. by filtering), to obtain the silica material. The silica material may be washed with water (e.g. distilled water), followed by an organic solvent (such as an alcohol, e.g. isopropanol, ethanol, methanol, or a combination thereof).

Step ii) may further comprise drying (e.g. oven drying) the silica material, following washing.

Step ii) may further comprise milling the silica material (e.g. using a ball mill). This may densify the material and improve workability in composite cements and concretes.

According to another aspect of the present invention there is provided a use of an organic solvent to extract a silica component from a mixture comprising a metal salt component and a silica component, optionally wherein the mixture is formed by contacting a metal silicate material with an aqueous acid. The organic solvent, silica component, and/or metal salt component may be as described herein. The metal silicate material may be as described herein.

### Carbonation Step

Processes according to the invention further comprise a carbonation step (e.g. step b according to the first and second aspects of the invention). This may sequester CO₂, for example to capture carbon emissions from industrial processes, including but not limited to cement production. Thus, the carbonation step provides a means of carbon capture and storage, allowing the production of reduced carbon composite cements (e.g. carbon neutral composite cements or carbon negative composite cements) and/or reduced carbon emissions from many essential industrial processes.

The steps of preparing silica material from metal silicate material and of carbonating the metal salt component also obtained from the metal silicate material are net carbon negative; thus, these process steps allow the production of a net carbon negative SCM, in the form of the silica material.

The carbonation step involves carbonating the metal salt component to produce a carbonate material. The metal salt component may be aqueous (e.g. part of an aqueous mixture obtained from step ii) following the extraction of the silica component). The carbonation may comprise contacting the metal salt component with carbon dioxide (or a source of carbon dioxide) and a base. For example, a CO₂ gas stream may be bubbled through a solution comprising the metal salt component and a base (e.g. for at least about minutes, optionally at least about 10 minutes, optionally at least about 15 minutes, optionally at least about 30 minutes, optionally for at least about 1 hour, optionally for at least about 2 hours). The base may be a hydroxide base, such as ammonium hydroxide (NH₄OH). The base may be ammonia (NH₃). The addition of base is to increase pH in order for carbonate material to precipitate from the mixture (e.g. from the aqueous solution). The pH may be adjusted to from about 8 to about 11, optionally from about 9 to about 10, optionally from about 9.5 to about 10.0. The skilled person will appreciate that an appropriate amount of base may be added in order to achieve the desired pH. The amount of carbon dioxide may also be controlled in order to obtain the desired pH. For example, carbon dioxide and ammonia may be introduced at the appropriate concentrations to achieve and maintain the desired pH.

The carbonate material may be isolated (e.g. filtered off from the aqueous mixture). The carbonate material may be washed (e.g. with water, e.g. distilled water). The carbonate material may be dried, for example by heating (e.g. to about 40° C.).

Base (e.g. NH₄OH) may be added to the metal salt component prior to carbonating (e.g. to increase the pH to about 3 to about 8, optionally to about 3 to about 7, optionally about 7) to form a precipitate which may be removed (e.g. by filtration), prior to carbonation. The precipitate may contain metal hydroxide (for example, trivalent metal hydroxide). For example, when the metal silicate used in the process is olivine, iron salts may precipitate out and be removed (e.g. by filtration) in order to obtain a solution consisting essentially of magnesium salts. If iron salts are removed, following carbonation, magnesium carbonate is obtained as the carbonate material (e.g. hydrated magnesium carbonates).

The carbonation step may use an industrial waste gas comprising CO₂. For example, the carbonation step may use an industrial flue gas having at least about 5% CO₂ by volume, for example a flue gas from cement production. Therefore, the carbonation step may use CO₂ obtained as a byproduct of cement production, thereby directly sequestering CO₂ obtained from cement production. For example, plant for carrying out processes according to the invention could be placed alongside current cement plants to make use of CO₂ emissions directly from the source.

The carbonate material obtained by the carbonating step may be further processed. For example, portions of the carbonate material (or the entirety of the carbonate material) may be blended with cement, for use as a filler. Portions of the carbonate material (or the entirety of the carbonate material) may be blended with cement and the silica material obtained according to step a) to obtain a composite cement according to the blending step described herein.

Advantageously, the carbonate material (e.g. hydrated magnesium carbonates) may be used as a means of carbon capture and storage, to sequester CO₂. For example, the carbonate material may be thermally stable and non-reactive with acid rain, thus suitable for geological storage. The carbonate material may be further processed for long-term storage. For example, the carbonate material may be transported and placed at a long-term storage site, for example, above ground (as a storage-stable CO₂-sequestering material), below ground, or in the deep ocean. The carbonate material may be stored in the form of bricks or blocks.

### Blending Step

Processes according to the first and second aspects of the invention comprise the step of blending the silica material, cement, and optionally a carbonate material to obtain the composite cement. Where carbonate material is blended, this may comprise carbonate material obtained following the carbonation step described herein.

The skilled person will appreciate that the proportions of silica material, cement, and optionally carbonate material used in the blend can be varied in order to obtain composite cements with the desired properties. For example, high strength composite cement can be obtained by using no or low quantities of carbonate material (or other fillers). The skilled person will appreciate that the proportions of silica material, cement, and optionally carbonate material that are blended together correspond to the weight percents of silica material, cement, and optionally carbonate material present in the composite cement, as described herein.

The skilled person will appreciate that a variety of composite cements may be provided according to the processes of the present invention. The blending step may include blending a further material such as a supplementary cementitious material (SCM). The SCM may be alumina and/or alkali rich SCM, for example fly ash (e.g. calcareous fly ash), ground granulated blast furnace slag, calcined clay, or a combination thereof.

The blended, composite cement may be further processed to form cement paste, by hydrating (e.g. mixing with water). The skilled person will appreciate that the amount of water added can be varied to obtain a hydrated cement with the desirable properties (e.g. in terms of workability and strength). For example, water may be added at a water/binder (w/b) ratio of 0.5 (wherein “binder” refers to the composite cement). The cement paste may be mixed with aggregate (such as sand, gravel, and/or crushed rock) to form a concrete or mortar. The amount of aggregate added can be varied depending on the desired properties of the concrete or mortar. For example, aggregate (e.g. fine aggregate having an average particle size of less than 5 mm) may be added at a composite:aggregate ratio of about 1:3.

### Acid Regeneration

Processes according to the invention may further comprise an acid regeneration step, occurring after the carbonation step. Base may also be regenerated in the acid regeneration step. The acid regeneration may comprise a thermal or chemical decomposition. The acid regeneration may comprise a hydrolysis (e.g. XA+H₂O→XOH+HA).

Acid regeneration is well-known in the art. The acid regeneration step may be carried out using any procedure known in the art. For example, the acid regeneration step may be carried out using a procedure described in U.S. Pat. No. 3,364,202A or WO 03/027018 (both incorporated by reference herein in their entirety), for the recovery of free sulfuric acid.

An exemplary method of acid regeneration is as follows. The filtrate obtained following the filtering off of the carbonate precipitate may be evaporated to form a powder. For example, when the aqueous acid used in step i) is H₂SO₄ and the base used in the carbonation is ammonium hydroxide (NH₄OH), the resulting powder obtained after evaporation is a solid ammonium sulphate (NH₄)₂SO₄ powder. This may be heated, e.g. to 250° C., to form solid ammonium bisulphate, (NH₄)HSO₄ and ammonia gas. The solid ammonium bisulphate may be dissolved, e.g. in hot water, to produce a saturated or super saturated solution of aqueous bisulphate. Advantageously, a supersaturated solution of ammonium bisulphate may increase regeneration yields.

An anti-solvent precipitation method may be used to precipitate a double salt comprising the formula (NH₄)₃H(SO₄)₂. This method may involve addition of an organic alcohol such as MeOH or EtOH. The (NH₄)₃H(SO₄)₂ salt may be hydrated, e.g. in hot water, before a second addition of organic alcohol, precipitating ammonium sulphate (NH₄)₂SO₄ and aqueous H₂SO₄ in the organic alcohol phase. The organic alcohol aqueous acid phase may be distilled, and the alcohol collected. The aqueous acid can be reused in the dissolution of a metal silicate (such as magnesium silicate mineral, e.g. olivine). An acid of the required concentration (so that no further dilution or concentration is required prior to its use in the dissolution reactions) can be obtained by controlling by the amount of water in the organic alcohol phase.

The acid used in step i) of the processes of the invention may be obtained from the acid regeneration step.

The base optionally used in step ii) and/or the carbonating step may be regenerated. Preferably, step ii) and the carbonating step utilise the same base (e.g. ammonium hydroxide), in order to facilitate base regeneration.

If ammonium hydroxide is used as a base in step ii) and/or the carbonating step, ammonia gas can be collected during the acid regeneration process. This may be dissolved in water to reform ammonium hydroxide, or the ammonia gas may be introduced directly into step ii) and/or the carbonating step. If magnesium oxide is used as the base, this can be regenerated by calcining magnesium carbonate (formed from the carbonating step).

### Silica Material

The silica material described herein comprises amorphous silica (e.g. amorphous precipitated silica). The silica material may also comprise metal silicate. The silica material may also comprise metal silicate particles coated in amorphous silica, such as amorphous precipitated silica (e.g. partially reacted metal silicate from the processes described herein). As described herein, metal silicate particles coated in amorphous silica may be referred to as engineered reactive filler. The silica material may comprise additional components, such as alumina and/or aluminosilicate.

The silica material may comprise at least about 50%, optionally at least about 60%, optionally at least about 70%, optionally at least about 80%, optionally at least about 85% amorphous silica by weight relative to the total weight of the silica material. The silica material may comprise at most about 50%, optionally at most about 40%, optionally at most about 30%, optionally at most about 20% optionally at most about 15% metal silicate by weight relative to the total weight of the silica material. The weight percents of amorphous silica and metal silicate may be obtained using X-ray fluorescence. Weight percent may be written as “% by weight”, “w/w %”, or “wt %”.

The metal silicate in the silica material may comprise unreacted metal silicate and/or partially reacted metal silicate. For example, the silica material may comprise at most about 20%, optionally at most about 15%, optionally at most about 10%, optionally at most about 5% unreacted metal silicate relative to the total silica material. The silica material may comprise at most about 30%, optionally at most about 20%, optionally at most about 15%, optionally at most about 10% partially reacted metal silicate relative to the total silica material. The percent may be by weight or by volume. As described herein, partially reacted metal silicate may be referred to as metal silicate particles coated in amorphous silica. The amount of unreacted metal silicate and partially reacted metal silicate present may be quantified by XRF analysis and mass balance calculation, in which case the percents would be by weight. The amount of unreacted metal silicate and partially reacted metal silicate present may be quantified by analysing SEM images of the silica material, in which case the percents would be by volume.

According to another aspect of the present invention there is provided a silica material obtainable by a process described herein (e.g. a process according to the third aspect of the invention). The silica material may be obtained by a process described herein (e.g. a process according to the third aspect of the invention).

According to another aspect of the present invention there is provided a use of the silica material described herein in a composite cement. The composite cement may be a composite cement as described herein.

### Carbonate Material

As discussed herein, the carbonate material can be used for long-term storage of carbon dioxide. For example, the carbonate material represents a means to capture and store carbon emissions from industrial processes, such as the production of cement. The skilled person will appreciate that the carbonate material will comprise metal carbonates wherein the metal corresponds to one or more metals present in the metal silicate material. For example, when the metal silicate material comprises an alkali earth silicate, the metal salt component comprises alkali earth salts and the carbonate material comprises alkali earth carbonates. For example, when the metal silicate material comprises magnesium silicate (e.g. magnesium iron silicate such as olivine) the metal salt component comprises magnesium salts and the carbonate material comprises magnesium carbonate (e.g. hydrated magnesium carbonate, e.g. nesquehonite). A metal salt component derived from olivine may also comprise iron salts, which may be removed prior to carbonation as described herein.

According to another aspect of the present invention there is provided a carbonate material obtainable by a process described herein. The carbonate material may be obtained by a process described herein. The carbonate material may be as described herein.

According to another aspect of the present invention there is provided a use of the carbonate material described herein for storage of carbon dioxide. Also provided is a use of the carbonate material for carbon capture and storage. For example, carbonate material may be blended with cement (e.g. to obtain a composite cement described herein), as a filler, in order to achieve long-term storage of carbon dioxide. The carbonate material may be used for geological storage of carbon dioxide. For example, the carbonate material may be transported and placed at a long-term storage site, for example, above ground, below ground, or in the deep ocean. Portions of the carbonate material (or the entirety of the carbonate material) may be blended with cement and the silica material obtained according to step a) to obtain a composite cement, according to the blending step described herein.

The carbonate material may be used to make bricks or blocks. Advantageously, the process for making bricks or blocks is low energy and inherently low-carbon process.

### Composite Cement

The composite cement described herein comprises a silica material, cement (e.g. Portland cement), and optionally a carbonate material. The composite cement may consist essentially of (e.g. may consist of) silica material and cement (e.g. Portland cement). The composite cement may comprise a silica material, cement (e.g. Portland cement), and a carbonate material.

The composite cement may comprise at least about 60 w/w % silica material relative to the total weight of the non-cement components in the composite cement. For example, when the composite cement consists of silica material, cement (e.g. Portland cement), and carbonate material, the composite cement may consist of at least about 60 w/w % relative to the total weight of the non-cement components, wherein the non-cement components are the silica material and the carbonate material. The composite cement may comprise at least about 70%, optionally at least about 80%, optionally at least about 90% by weight silica material relative to the total weight of the non-cement components in the composite cement.

The composite cement may comprise at most about 40%, optionally at most about 30%, optionally at most about 20%, optionally at most about 10% by weight of carbonate material relative to the total weight of the non-cement components in the composite cement. As discussed herein, the carbonate material may act as a filler.

The composite cement may comprise at least about 60%, optionally at least about 70%, optionally at least about 80%, optionally at least about 90% by weight of silica material relative to the total weight of the silica material and the carbonate material. The composite cement may comprise at most about 40%, optionally at most about 30%, optionally at most about 20%, optionally at most about 10% by weight of carbonate material relative to the total weight of the silica material and the carbonate material.

The composite cement may comprise at most about 20 w/w %, optionally at most about 15 w/w %, optionally at most about 10 w/w %, optionally at most about 5 w/w % carbonate material relative to the total weight of the composite cement.

The composite cement may comprise from about 20 w/w % to about 60 w/w % carbonate material relative to the total weight of the composite cement; optionally from about 20 w/w % to about 55 w/w %, optionally from about 20 w/w % to about 50 w/w % relative to the total weight of the composite cement. The carbonate material may be carbonate material obtained by a process according to the present invention. Advantageously, a composite cement containing such carbonate material provides a means for long term carbon storage.

The composite cement may comprise at least about 5%, optionally at least about 10%, optionally at least about 15%, optionally at least about 20%, optionally at least about 25%, optionally at least about 30% of silica material by weight relative to the total weight of the composite cement; optionally wherein the composite cement comprises about 35 w/w % of silica material relative to the total weight of the composite cement. The composite cement may comprise at most about 60 w/w %, optionally at most about 50 w/w %, optionally at most about 40 w/w % silica material relative to the total weight of the composite cement.

The composite cement may comprise at least about 20%, optionally at least about 30%, optionally at least about 40%, optionally at least about 50%, optionally at least about 60% of cement (e.g. Portland cement) by weight relative to the total weight of the composite cement; optionally wherein the composite cement comprises about 65 w/w % of cement relative to the total weight of the composite cement.

The composite cement may comprise at least about 35 w/w % of silica material relative to the total weight of the composite cement, for example about 35 w/w % of silica material. At these weight percents, the carbon emissions from the manufacture of Portland cement are entirely captured, resulting in a carbon neutral or carbon negative composite cement. This is not currently possible with existing SCMs such as ground granulated blast furnace slag or fly ashes. According to industry standards for composite cements, SCM contents of up to 35% (CEM II/B) or up to 50% (CEM II/C) are allowed by current standards (see EN197-1:2011 and EN197-5:2021, incorporated by reference in their entirety). Therefore, advantageously, a carbon neutral composite cement according to the present invention (e.g. having about 35 w/w % of silica material) or a carbon negative composite cement according to the present invention (e.g. having greater than 35% silica material and no more than 50% silica material) complies with existing standards.

The composite cement may comprise about 35 w/w % of silica material and about 65 w/w % cement (e.g. Portland cement), relative to the total weight of the composite cement. This may result in a high strength, carbon neutral composite cement. The composite cement may comprise at most about 35 w/w % of silica material and at least about 65 w/w % cement, relative to the total weight of the composite cement. Such composites are high strength, due to the relatively high proportion of cement (e.g. Portland cement).

High filler carbon neutral cements are also envisaged, for example those that incorporate substantially all the carbonate material obtained by processes of the present invention. For example, a composite cement comprising about 33 w/w % cement (e.g. Portland cement), about 18 w/w % silica material, and about 49 w/w % carbonate material is provided. This may be carbon neutral and may incorporate all carbonate material produced by processes according to the invention.

According to another aspect of the present invention there is provided a composite cement obtainable according to a process of the first and second aspects of the invention. The composite cement may be obtained according to a process of the first and second aspects of the invention. The composite cement may be a composite cement as described herein.

According to another aspect of the present invention there is provided a composite cement comprising a silica material, cement (e.g. Portland cement), and optionally a carbonate material, wherein the composite cement comprises at least about 60 w/w % silica material relative to the total weight of the non-cement components (e.g. relative to the total weight of silica material and carbonate material) in the composite cement, and at least about 5% silica material relative to the total weight of the composite cement. The composite cement may be a composite cement as described herein.

The skilled person will appreciate that a variety of composite cements may be provided according to the present invention. The composite cement may further comprise a further material such as a supplementary cementitious material. For example, the composite cement may comprise alumina and/or alkali rich SCMs. The composite cement may comprise fly ash (e.g. calcareous fly ash), ground granulated blast furnace slag, calcined clay, or a combination thereof.

The composite cement may be further processed to form cement paste, by hydrating (e.g. mixing with water). The cement paste may be mixed with aggregate (such as sand, gravel, and/or crushed rock) to form a concrete or mortar. Also provided herein is a concrete comprising a composite cement described herein and aggregate. The aggregate may be a mixture of fine aggregate (e.g. having an average particle size of less than 5 mm) and course aggregate (e.g. having an average particle size of at least 5 mm). Also provided herein is a mortar comprising a composite cement described herein and aggregate. The aggregate may be fine aggregate (e.g. having an average particle size of less than 5 mm). The concrete or mortar may have a composite:aggregate ratio of about 1:3.

Features described above in relation to each aspect of the present invention also represent features of each other aspect of the present invention subject to a technical incompatibility that would prevent such a combination of preferred features. Furthermore, it will be evident to the skilled person that advantages set out above in respect of each aspect of the present invention are also offered by each other aspect of the present invention.

### EXAMPLES

The following examples are merely illustrative examples of the invention described herein and are not intended to be limiting upon the scope of the invention.

### Example 1a: Preparation of a Silica SCM Using Sulfuric Acid

0.125 kg of ground olivine was dissolved in 0.5 L 3 M sulphuric acid (˜20% stoichiometric excess of olivine). This was reacted at 80-100 C for 90 mins (preferably as close to 100 as possible, without evaporating water). Temperature was maintained through the exothermic dissolution reaction itself. The vessel was wrapped in insulating jacket to maintain heat. 0.15 L isopropanol was added and phase separation was carried out. Specifically, isopropanol (IPA) was added to the reacted mixture to separate out two phases; one silica rich organic phase in the upper portion of the reaction vessel, the second an aqueous magnesium sulphate rich phase. The two phases were separated by drawing the desired phase from the top or bottom of the vessel respectively.

The silica rich organic layer was dried and the IPA recovered. 0.045 kg silica was washed in water and oven dried. The silica was milled in a ball mill for 18 h to densify and regulate particle shape.

0.3 L MgSO₄ solution, obtained from the separation, was transferred to a carbonation vessel. Carbonation with CO₂ gas stream for 2 h (0.066 kg), gas stream CO₂ concentration from 5-99%, was carried out. The pH was adjusted by the addition of NH₄OH, to a pH of 9.5-10 (optimal for carbonation precipitation).

0.20 kg carbonate precipitate (nesquehonite) was filtered and washed before oven drying.

Silica, carbonate and cement were blended together in varying proportions to produce binders with tailorable properties.

The following blends are preferred (in percentages, cement:silica:carbonate):
Carbon neutral (65:35:0)
Carbon neutral high-filler (33:18:49)
High strength (variable 65+: 35−: 0, depending on required properties).

### Example 1b: Analysis of the Silica SCM Obtained in Example 1a

Scanning electron microscope (SEM) images of ground silica material obtained according to Example 1 were obtained (FIG. 2). A powder sample of the silica material was placed in the SEM, using secondary electron (SE) mode, accelerating voltage 5-10 kV, and magnification 4 k-8 kx.

Chemical analysis was carried out using X-ray fluorescence (XRF), to describe the chemical composition of the silica SCM and calculated mineral phases as shown below. XRF was carried out using an Edax® Orbis PC CDG MicroXRF elemental analyser.

| Oxide | Wt % |
|---|---|
| SiO₂ | 84.15 |
| MgO | 7.299 |
| SO₃ | 3.540 |
| Fe₂O₃ | 1.597 |

This corresponds to approx. 94.2% reactive silica, 4.3% unreacted magnesium silicate (olivine) and 1.5% sulfate-containing impurities.

### Example 2a: Preparation of a Silica SCM Using HCl

### Dissolution

Olivine ((Mg²⁺, Fe²⁺)₂ SiO₄) was ground to a powder ranging from 40 to 150 μm (as measured using laser diffraction with liquid dispersion). 500 ml of 2M HCl was placed in a 1 L beaker on a hotplate with a Teflon coated metal stirring bar. The acid was heated to 60° C. prior to addition of 70 g of ground olivine (2:1 molar excess). Dissolution was run for 90 minutes and the solution was left to stand for 1 hour to allow undissolved solids to settle. The resulting supernatant solution containing aqueous Mg/Fe chlorides, and dissolved silica monomers (silicic acid) was decanted from undissolved solids (Eq. 1).

$${( M {g}^{2 +} , {Fe}^{2 +} )}_{2} S i {O}_{4} + 4 HCl \to 2 ( M {g}^{2 +} , {Fe}^{2 +} ) {Cl}_{2} ( aq ) + {H}_{4} {SiO}_{4} ( aq ) \qquad ( Eq . 1 )$$

### Precipitation

The supernatant from olivine dissolution was placed in a 1 L beaker. An MgO slurry prepared by mixing 0.5 g MgO with 10 ml of deionised water was added under constant stirring. The MgO slurry addition increased the pH from 3.1-3.5 to approx. 4.5-5.0. An increase in pH precipitates SiO₂ as a gel (APS) through a condensation polymerisation (Eq. 2). The solution was passed through a fine muslin cloth to separate solids. The remaining supernatant was a 1.0 M (Mg²⁺, Fe²⁺)Cl₂ solution. The APS was washed twice with distilled water to remove remaining ions followed by an IPA/H₂O solvent exchange prior to controlled drying of APS.

$${H}_{4} {SiO}_{4} ( aq ) \to Si {O}_{2} ( gel ) + 2 {H}_{2} O \qquad ( Eq . 2 )$$

### MqCl₂ Carbonation

NH₄OH (5 ml) was added to the (Mg²⁺, Fe²⁺)Cl₂ solution to increase pH to 7 forming an Fe(OH)₂ precipitate (Eq. 3). Fe(OH)₂ was filtered resulting in a pale blue MgCl₂ solution. MgCO₃·3H₂O particles were synthesised by pH-controlled carbonation of the MgCl₂ solution. Carbon dioxide gas was bubbled through the solution under constant stirring at a rate of approximately 25 mL/min.

The following equation provides stoichiometry for an olivine that contains 5% Fe in place of Mg.

$$1. ( M {g}^{2 +} , {Fe}^{2 +} ) {Cl}_{2} + 0.1 N {H}_{4} O H \to 0.95 {MgCl}_{2 ( aq )} + 0.05 {Fe ( OH )}_{2 ( ppt )} + 0.1 N {H}_{4} {Cl}_{( aq )} \qquad ( Eq . 3 )$$

$${MgCl}_{2 ( aq )} + C {O}_{2} + 2 N {H}_{4} O H + {H}_{2} O \to M g C {O}_{3} 3 {H}_{2} O + 2 {NH}_{4} Cl \qquad ( Eq . 4 )$$

Adjustments to pH were made through the addition of 1 ml NH₄OH (Aldrich 35%) solution at regular intervals. An initial pH of 4.5-5.0 post silica precipitation was increased over time (1 h) to a final pH of 9, at which point carbonate precipitation is complete (Eq. 4). Carbonate precipitate was separated by filtration, followed by washing twice with distilled water. Carbonate samples were dried in a 40° C. oven for 24 hours before analysis.

### Example 2b: Analysis of the Silica SCM Obtained in Example 2a

The following results are presented:
Compressive strength of a CEM I 52.5R, a fly ash (FA) blended cement, and a blended cement incorporating silica SCM obtained by Example 2a. Both the blended cements were prepared using the same CEM I 52.5R. (EN197-1:2011 provides the chemical requirements for a CEM I cement and performance requirements for a 52.5R cement. FA (siliceous) blended cement is a CEM II/B-V cement.)
Reactivity (in terms of pozzolanic activity) of the silica SCM compared to fly ash, determined via a saturated lime test.
Chemical analysis, using X-ray fluorescence (XRF), to describe the chemical composition of the silica SCM and calculated mineral phases.

The compressive strength compressive strength test was carried out on 25 mm paste cubes prepared at a 0.5 water/binder (w/b) ratio. Cubes were tested on a hydraulic press, at a loading rate of 0.3 MPa/s. The results are shown below:

Compressive Strength (MPa)

| Mix | 3 d | 28 d |
|---|---|---|
| CEM I 52.5R | 26.4 | 49.8 |
| 80% CEM I + 20% | 25.4 | 46.0 |
| silica material | | |
| 65% CEM I + 35% | 24.6 | 41.1 |
| silica material | | |
| 80% CEM I + 20% | 17.5 | 37.1 |
| fly ash (FA) | | |
| 65% CEM I + 35% | 18.2 | 29.2 |
| FA | | |

A compressive strength test can be carried out on 50 mm mortar cubes containing composite:fine aggregate (<5 mm) at a ratio of 1:3 and a 0.5 water/binder (w/b) ratio.

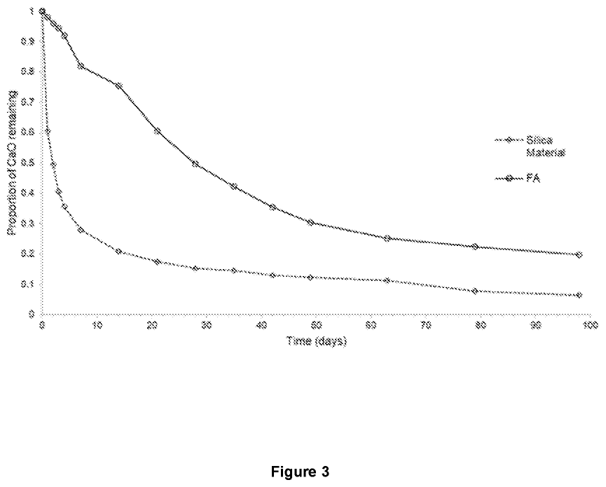

The saturated lime test was carried out according to the method described in Donatello et al (Cement and Concrete Composites, 32(2), 2010, 121-127; incorporated by reference in its entirety). Saturated lime test results are shown in FIG. 3.

Chemical analysis using XRF was carried out using an Edax® Orbis PC CDG MicroXRF elemental analyser. The results are shown below:

| Oxide | Wt % |
|---|---|
| MgO | 6.15 |
| SiO₂ | 90.31 |
| Cl₂O | 0.52 |
| Fe₂O₃ | 3.02 |

This corresponds to approx. 85.0% reactive silica, 13.7% unreacted magnesium silicate (olivine) and 1.3% chloride-containing impurities.

### Example 3: Acid Regeneration

The ammonium sulphate solution resulting from the carbonation step of Example 2 was evaporated to form a solid ammonium sulphate (NH₄)₂SO₄ powder.

The solid ammonium sulphate powder was heated to the initial decomposition step temperature (250 C) but below the full decomposition temperature (400 C) until constant mass is achieved (Eq. 5)

$$6 {( {NH}_{4} )}_{2} {SO}_{4 ( s )} \to 6 ( N {H}_{4} ) H S {O}_{4 ( s )} + 6 N {H}_{3 ( g )} \qquad ( Eq . 5 )$$

Solid ammonium bisulphate (NH₄)HSO₄ was dissolved in hot water to produce a saturated or super saturated solution of aqueous bisulphate.

An anti-solvent precipitation method was used to precipitate a double salt comprising the formula (NH₄)₃H(SO₄)₂. The resulting liquid phase contained an organic alcohol such as MeOH or EtOH and a diluted H₂SO₄ acid (Eq. 6)

$$6 ( {NH}_{4} ) H S {O}_{4 ( aq )} \to 2 {( N {H}_{4} )}_{3} {H ( S {O}_{4} )}_{2 ( s )} + 2 {H}_{2} {SO}_{4 ( aq )} . \qquad ( Eq . 6 )$$

The (NH₄)₃H(SO₄)₂ salt was hydrated in hot water before a second addition of organic alcohol, precipitating ammonium sulphate (NH₄)₂SO₄ and aqueous H₂SO₄ in the organic alcohol phase (Eq. 7)

$$2 {( {NH}_{4} )}_{3} {H ( {SO}_{4} )}_{2 ( aq )} \to 3 {( N {H}_{4} )}_{2} S {O}_{4 ( s )} + {H}_{2} {SO}_{4 ( aq )} . \qquad ( Eq . 7 )$$

The organic alcohol aqueous acid liquid phase was distilled, and the alcohol collected.

The aqueous acid can be reused in the dissolution of a magnesium silicate mineral (olivine).

The skilled person would appreciate that an acid of the required concentration can be produced so that no further dilution or concentration is required prior to its use in the dissolution reactions. This is controlled by the amount of water in the organic alcohol phase.

The overall reaction is as follows (Eq. 8)

$$6 {( N {H}_{4} )}_{2} S {O}_{4 ( s )} \to 3 ( N {H}_{4} ) S {O}_{4 ( s )} + 3 N {H}_{3 ( g )} + 3 {H}_{2} {SO}_{4 ( aq )} \qquad ( Eq . 8 )$$

While preferred embodiments of the present invention have been shown and described herein, it will be apparent to those skilled in the art that such embodiments are provided by way of example only. It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

1. A process for preparing a composite cement comprising a silica material, cement, and optionally a carbonate material; wherein the process comprises the steps:
a) preparing the silica material by:
i) contacting a metal silicate material with an aqueous acid to form a mixture comprising a silica component and a metal salt component;
ii) extracting the silica component from the metal salt component, to obtain the silica material, wherein the extraction comprises contacting the mixture with an organic solvent and separating the silica component from the metal salt component; or wherein the extraction comprises separating the silica component from the metal salt component; and washing the silica component with water, followed by an organic solvent;
b) carbonating the metal salt component to produce a carbonate material; and
c) blending the silica material, cement, and optionally a carbonate material to obtain the composite cement.

2. The process of claim 1, wherein the composite cement comprises at least about 60 w/w % silica material relative to the total weight of the non-cement components in the composite cement.

3. A process for preparing a composite cement comprising a silica material, cement, and optionally a carbonate material; wherein the process comprises the steps:
a) preparing the silica material by:
i) contacting a metal silicate material with an aqueous acid to form a mixture comprising a silica component and a metal salt component;
ii) extracting the silica component from the metal salt component, to obtain the silica material; and
b) carbonating the metal salt component to produce a carbonate material;
c) blending the silica material, cement, and optionally a carbonate material to obtain the composite cement;
wherein the composite cement comprises at least about 60 w/w % silica material relative to the total weight of the non-cement components in the composite cement.

4. The process of claim 3, wherein the extraction of step ii) comprises contacting the mixture with an organic solvent and separating the silica component from the metal salt component; or wherein the extraction comprises separating the silica component from the metal salt component; and washing the silica component with water, followed by an organic solvent.

5. The process of claim 1, wherein:
A) the cement is Portland cement; and/or
B) the composite cement comprises a silica material, cement, and a carbonate material;
and wherein step c) comprises blending the silica material, cement, and a carbonate material to obtain the composite cement; optionally wherein the composite cement comprises carbonate material obtained in step b); and/or
C) the composite cement further comprises a further supplementary cementitious material such as calcareous fly ash, ground granulated blast furnace slag, calcined clays, or a combination thereof; and wherein step c) further comprises blending the further supplementary cementitious material.

6. The process of claim 1, wherein the composite cement comprises:
A) at least about 60%, optionally at least about 70%, optionally at least about 80%, optionally at least about 90% by weight of silica material relative to the total weight of the silica material and the carbonate material; and/or
B) the composite cement comprises at most about 40%, optionally at most about 30%, optionally at most about 20%, optionally at most about 10% by weight of carbonate material relative to the total weight of the silica material and the carbonate material.

7. The process of claim 1, wherein the composite cement comprises:
A) at most about 20% carbonate material by weight relative to the total weight of the composite cement; optionally at most about 15%, optionally at most about 10%, optionally at most about 5% by weight relative to the total weight of the composite cement; and/or
B) at least about 5%, optionally at least about 10%, optionally at least about 15%, optionally at least about 20%, optionally at least about 25%, optionally at least about 30% of silica material by weight relative to the total weight of the composite cement; optionally wherein the composite cement comprises about 35 w/w % of silica material relative to the total weight of the composite cement; and/or
C) the composite cement comprises at least about 20%, optionally at least about 30%, optionally at least about 40%, optionally at least about 50%, optionally at least about 60% of cement by weight relative to the total weight of the composite cement; optionally wherein the composite cement comprises about 65 w/w % of cement relative to the total weight of the composite cement.

8. The process of claim 1, wherein the composite cement comprises at most about 35 w/w % of silica material and at least about 65 w/w % cement, relative to the total weight of the composite cement; optionally wherein the composite cement comprises about 35 w/w % of silica material and about 65 w/w % cement, relative to the total weight of the composite cement.

9. The process of claim 1, wherein:
A) the composite cement comprises from about 20 w/w % to about 60 w/w % carbonate material relative to the total weight of the composite cement; optionally from about 20 w/w % to about 55 w/w %, optionally from about 20 w/w % to about 50 w/w % relative to the total weight of the composite cement;
B) at least about 5%, optionally at least about 10%, optionally at least about 15% of silica material by weight relative to the total weight of the composite cement; and/or
C) the composite cement comprises at least about 20%, optionally at least about 30% cement by weight relative to the total weight of the composite cement;
optionally wherein the composite cement comprises about 33 w/w % cement, about 18 w/w % silica material, and about 49 w/w % carbonate material.

10. A process for preparing a silica material comprising the steps:
i) contacting a metal silicate material with an aqueous acid to form a mixture comprising a silica component and a metal salt component; and
ii) extracting the silica component from the metal salt component, to obtain the silica material;
wherein the extraction comprises contacting the mixture with an organic solvent and separating the silica component from the metal salt component; or
wherein the extraction comprises separating the silica component from the metal salt component; and washing the silica component with water, followed by an organic solvent.

11. The process of claim 1, wherein the metal silicate material is a mineral and/or wherein the metal silicate material is a material comprising an alkali earth silicate, an alkali earth aluminosilicate, hydroxysilicate, or a combination thereof; optionally wherein the metal silicate material is olivine or the metal silicate material is waste cement paste.

12. The process of claim 1, wherein:
A) the aqueous acid used in step i) is a mineral acid; optionally wherein the aqueous acid used in step i) is aqueous H₂SO₄ or HCl; and/or
B) there is a stoichiometric excess of metal silicate material with respect to the aqueous acid, during step i); optionally wherein the molar ratio of metal silicate to acid is from about 0.5:1 to about 2:1, optionally from about 1.25:1 to about 1.5:1.

13. The process of claim 1, wherein:
A) step ii) further comprises the addition of a base, such as magnesium oxide, ammonium hydroxide or ammonia, prior to separating the silica component from the metal salt component; and/or
B) the extraction of step ii) comprises contacting the mixture with an organic solvent and separating the silica component from the metal salt component; optionally wherein the organic solvent is an alcohol, such as isopropanol, ethanol, methanol, or a combination thereof.

14. The process of claim 1, wherein the silica material comprises amorphous silica; and optionally further comprises metal silicate, such as unreacted metal silicate and/or partially reacted metal silicate; optionally wherein:
A) the silica material comprises at least about 50%, optionally at least about 60%, optionally at least about 70%, optionally at least about 80%, optionally at least about 85% amorphous silica by weight relative to the total weight of the silica material; and/or
B) the silica material comprises at most about 50%, optionally at most about 40%, optionally at most about 30%, optionally at most about 20% optionally at most about 15% metal silicate by weight relative to the total weight of the silica material.

15. The process of claim 10, wherein the process further comprises a step of carbonating the metal salt component, to produce a carbonate material.

16. The process of claim 1, wherein:
A) the carbonating comprises contacting the metal salt component with carbon dioxide and a base; optionally wherein the base used in the carbonating step is ammonium hydroxide or ammonia, and/or wherein the pH is adjusted to from about 9.5 to about 10 upon addition of the base and the carbon dioxide in the carbonating step; and/or
B) the carbonating is carried out using an industrial flue gas having at least about 5% CO₂ by volume; optionally wherein the industrial flue gas is obtained as a byproduct of cement production; and/or
C) prior to the carbonating, base is added to the metal salt component to adjust the pH to from about 3 to about 8 (e.g. from about 3 to about 7) and resulting precipitate is removed; and/or
D) the carbonate material is isolated, optionally washed, and optionally dried.

17. The process of claim 1, wherein the process further comprises an acid regeneration step, occurring after the carbonation step; optionally wherein:
A) the acid used in step i) is obtained from the acid regeneration step; and/or
B) the base used in step ii) and/or the carbonating step is obtained from the acid regeneration step.

18. The process of claim 1, further comprising:
A) drying the silica component; and/or
B) milling of the silica component; and/or
C) grinding the metal silicate material prior to contacting it with aqueous acid.

19. (canceled)

20. A silica material obtainable by the process of claim 10.

21. A composite cement comprising the silica material of claim 20.

22. A carbonate material obtainable by the process of claim 15.

23. A carbon capture and storage material comprising the carbonate material of claim 22.

24. (canceled)

25. A composite cement comprising a silica material, cement, and optionally a carbonate material, wherein the composite cement comprises at least about 60 w/w % silica material relative to the total weight of the non-cement components in the composite cement, and at least about 5 w/w % silica material relative to the total weight of the composite cement.
